(19) United States
(12) Patent Application Publication
(10) Pub. No.: US 2016/0156603 A1
(43) Pub. Date: Jun. 2, 2016

(54) Low Power Secure User Identity Authentication Ring

(71) Applicant: Craig Janik, Palo Alto, CA (US)

(72) Inventor: Craig Janik, Palo Alto, CA (US)

(21) Appl. No.: 14/954,617

(22) Filed: Nov. 30, 2015

Related U.S. Application Data
(60) Provisional application No. 62/085,497, filed on Nov. 28, 2014.

(51) Int. Cl. H04L 29/06; G06Q 20/32; G06Q 20/40

(52) U.S. Cl. CPC H04L 63/0492; G06Q 20/401; G06Q 20/3278; H04L 63/08

(57) ABSTRACT

A wearable device (4) for secure execution of Near Field Communications identity-based data transactions with an enclosure (8) that contains a secure NFC integrated circuit (40), a secure Bluetooth Low Energy integrated circuit (48), a microcontroller (48) with a firmware program (104), a battery (44), and a passive sensor (16) that activates the microcontroller (48) when the device is removed or donned by the user. If the NFC integrated circuit (40) is in the enabled state when the microcontroller (48) is activated by the sensor (16), the firmware program (104) disables the NFC integrated circuit (40) function. If the NFC integrated circuit (40) is the disabled state when the microcontroller (48) is activated by the sensor (16), the Bluetooth Low Energy integrated circuit (48) is activated and a Personal Identification Number must entered into a software application (112) running on a Bluetooth-connected computing device (22) to enable the NFC integrated circuit (40) function.

This application claims the benefit of U.S. Provisional Application No. 62/085,497, filed Nov. 28, 2014, entitled Wearable Identity Authentication Device and System.

### FIELD OF THE INVENTION

The present invention is a wearable device for secure execution of Near Field Communications identity-based data transactions including but not limited to executing financial transactions and gaining access to secured facilities.

### BACKGROUND OF THE INVENTION

The current prevalent method for making cashless payments is by the use of a debit card, credit card, or Smart Card (hereafter referred to as a card or card system). A card transaction requires the card bearer to physically slide a card through a card reader, referred to here as the primary authentication method. A secondary level of authentication may be required that consists of either keying in a personal identification number (PIN) or by writing a signature with a digital stylus. The fundamental authentication method is based on the assumption that the card is in the possession of the owner of the associated financial account.

The security risk of the card system is that both the primary and secondary authentication methods are easily thwarted. Cards may be stolen and thus possession authentication is defeated. The secondary authentication method of PIN entry can be defeated by the fact that users are required to enter the code in public where the entry can be viewed by other customers or even recorded on video with a smartphone, or by inconspicuous placement of a small video camera, such as a GoPro camera. Many keypads on payment terminals include shrouds to limit the view of the keypad entry, but they are imperfect and the PIN can be usually be derived from the motion of the fingers.

The secondary authentication method of a written signature, either with ink or a digitized written signature, is inherently defeated if the card is stolen, since the card owner's written signature is on the back of the card. A motivated thief can easily mimic the card owner's signature.

Problems exist beyond the security risks of the card system, as the effort of producing the card is time-consuming. Many card users store the card in a wallet which in turn is kept in a pocket or purse. Executing the transaction requires extracting the wallet, extracting the card, swiping the card, placing the card back into the wallet and placing the wallet back in a pocket or purse.

Another problem with the card system is that banks now track consumer transactions and tend to error on the side of caution and may disable a consumer's card based on the appearance of fraudulency. In this case the consumer must wait to receive a new card in the mail and will not be able to make card transactions until the card is received.

An increasingly popular alternative to the card system is the use of a smartphone with a secure NFC communication sub-system. An example of this is the iPhone 6 manufactured by Apple, Inc. of Cupertino, Calif. The iPhone 6 includes a biometric fingerprint identification sub-system, software, and payment network infrastructure. However smartphone-based identity authentication systems also have problems. Methods for acquiring fingerprints and for creating fingerprint replicas able to defeat fingerprint sensors are widely disseminated on the internet. One example is Why I Hacked TouchID (again) and still thinks it's awesome—(https://blog.lookout.com/blog/2014/09/23/iphone-6-touchid-hack!).

Also smartphone payment systems have the same inconvenience as card systems in that the device has to be physically accessed and held up to an NFC reader with a finger placed on the fingerprint sensor, requiring time and effort by the user. One additional inconvenience unique to the smartphone-based payment system is that if the phone's battery runs down, the user cannot make payments. And obviously, if a smartphone is stolen, the user loses the ability to make payments.

WIPO Patent Application WO/2005/117527 entitled AN ELECTRONIC DEVICE TO SECURE AUTHENTICATION TO THE OWNER AND METHODS OF IMPLEMENTING A GLOBAL SYSTEM FOR HIGHLY SECURED AUTHENTICATION discloses a finger ring with internal electronics for secure communication with external base stations, for example by the use of USB and an IrDA (infra-red) communication mediums. The ring must be physically connected to the base station to receive power, which is inconvenient for the user. Another problem is that use of this device requires “one or more biometric cross-checks to verify the wearer as the genuine owner of the device of invention called as WIPAD (Wearable Identity Protection & Authentication Device)”. The use of this device is even more complicated than the existing card system and smartphone-based identity authentication.

What is required is a more convenient and secure method for authentication of a person's identity in a variety of situations. The method should be an inconspicuous wearable device that may be worn indefinitely, that is, not donned and doffed on a daily basis. The device should perform the basic transaction functions, similar to the card system, without requiring charging. And the device should cease to function for authenticating transactions if and when it is removed from the user's body, and provide a method for enabling authentication when the device is donned again.

### SUMMARY OF THE INVENTION

The present invention solves the aforementioned problems by providing a user identity authentication ring that provides encrypted NFC identity and data authentication when worn, and ceases to provide that function when removed from the user's body. The function can be re-enabled when the ring is again donned via an encrypted Bluetooth link to a user's smartphone or other device.

The user identity authentication ring includes an NFC radio-frequency (hereafter RF) communication sub-system for providing encrypted communication with an NFC base station, and a Bluetooth Low Energy RF sub-system for providing encrypted communication with a digital device such a smartphone or personal computer. The user identity authentication ring includes a battery but does not use battery power when used to authenticate transactions, as the NFC sub-system is passively powered by the NFC base station. The user identity authentication ring also includes a passive expansion sensor configured to apply battery power to the internal NFC and Bluetooth sub-systems when the expansion sensor senses the expansion of the ring, that is, when it is passed over the user's knuckle when it is removed or donned. The expansion sensor in combination with software programming in the Bluetooth and NFC chips, acts to disable the NFC authentication function when the expansion sensor is triggered. If the expansion sensor is triggered when the NFC authentication function is in a disabled state, i.e., when it is placed onto the finger, the Bluetooth LE sub-system is activated and a PIN must be entered into a software application running on a Bluetooth-connected device to enable the NFC authentication function.

Other objects and features of the present invention will become apparent by review of the specification, appended figures, and claims.

### LIST OF DRAWING FIGURES

FIG. 1. shows a wearable ring device.

FIG. 2. shows the internal components of the ring device without encapsulant.

FIG. 3. shows a ring device internal assembly.

FIG. 4. is a block diagram of the payment ring electronics subsystem.

FIG. 5. shows a detail view of the flexible circuit and battery connection.

FIG. 6. shows a ring device with encapsulant.

FIG. 7. shows the unexpanded and expanded states of the ring device.

FIG. 8. shows a detail view of the expansion sensor assembly.

FIG. 9. shows the ring with expansion sensor detail in the unexpanded state.

FIG. 10. shows the ring with expansion sensor detail in the expanded state.

FIG. 11. shows a side view of expansion flex and flex circuit.

FIG. 12. is a software stack diagram for the ring device.

FIG. 13. is a flow chart showing the function of BLE authentication software application.

FIG. 14. shows a ring device worn on the hand and an NFC reader.

FIG. 15. shows a ring device on an inductive charging stand.

FIG. 16. shows examples of ring sizing tools.

### DESCRIPTION OF THE EMBODIMENTS

### Hardware

### Mechanical Subsystem And Components

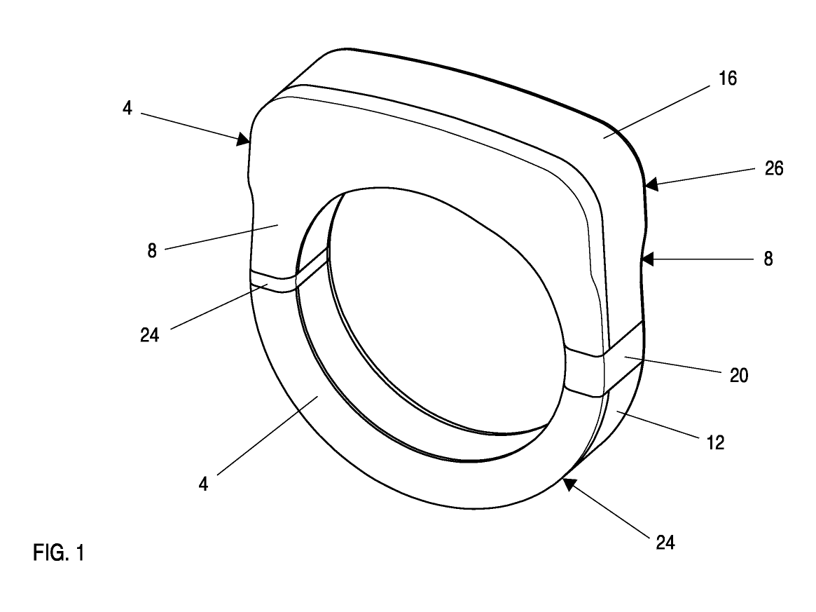

FIG. 1 shows a wearable finger ring device 4 that is similar in size and shape to a conventional ornamental finger ring. Ring 4 includes an external enclosure 8 that contains and protects the internal components and is comprised of a ring top cap 8, a ring bottom cap 4, a ring bottom cavity 12, a ring top cavity 16, an expander 20, and a hinge 24. Ring top 8, ring bottom 4, and ring cap 24 are manufactured by injection molding copolyester material, in this embodiment, the material is Tritan™, supplied by the Eastman Chemical Company of Kingsport, Tenn. Top cap 8 is fastened to top cavity 16 by ultrasonic welding. Likewise bottom cap 4 is fastened to bottom cavity 12 by ultrasonic welding. In another embodiment, top cap 8 and top cavity 16, and bottom cap 4 and bottom cavity 12 are fastened respectively, with epoxy. Top cap 8 and top cavity 16 together comprise top enclosure sub-assembly 26, and bottom cap 4 and bottom cavity 12 together comprise bottom enclosure sub-assembly 24.

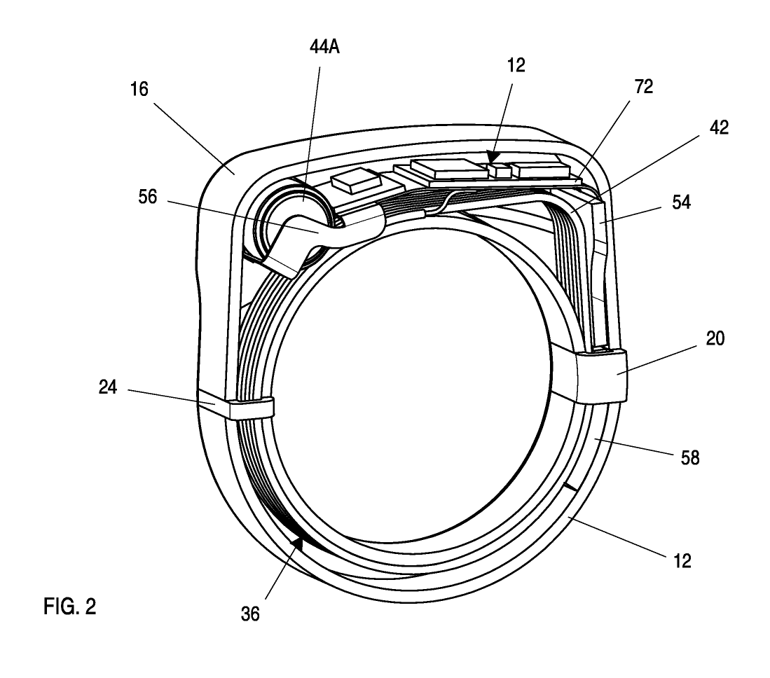

Referring now to FIG. 1 and FIG. 2, hinge 24 and expander 20 are comprised of a thermoplastic elastomer (TPE) material, in this embodiment, the material is Kraton© G7820, a styrenic block copolymer, manufactured by Kraton Polymers U.S., located in Houston, Texas. Hinge 24 and expander 20 are each comprised of a version of Kraton© that has a SHORE A 41 durometer rating. Hinge 24 and expander 20 are fastened to enclosure assembly 8 by the process of injection co-molding as the last assembly operation. The fastening methods used in the assembly of ring 4 external enclosure 8 results in an ingress protection rating of IP68—the device is dust tight and can be immersed in water.

In another embodiment, each of ring top cap 8, ring bottom cap 4, ring bottom cavity 12, and ring top cavity 16 are made of a composite material comprised of an epoxy resin binder with internal aramid fibers. In this embodiment top cap 8 is fastened to top cavity 16, and bottom cap 4 is fastened to bottom cavity 12, respectively, by the use of an epoxy resin. In another embodiment, top cap 8, top cavity 16, bottom cavity 12, and bottom cap 4 are comprised of a ceramic material with epoxy resin as the fastening material.

### Electrical Subsystem and Components

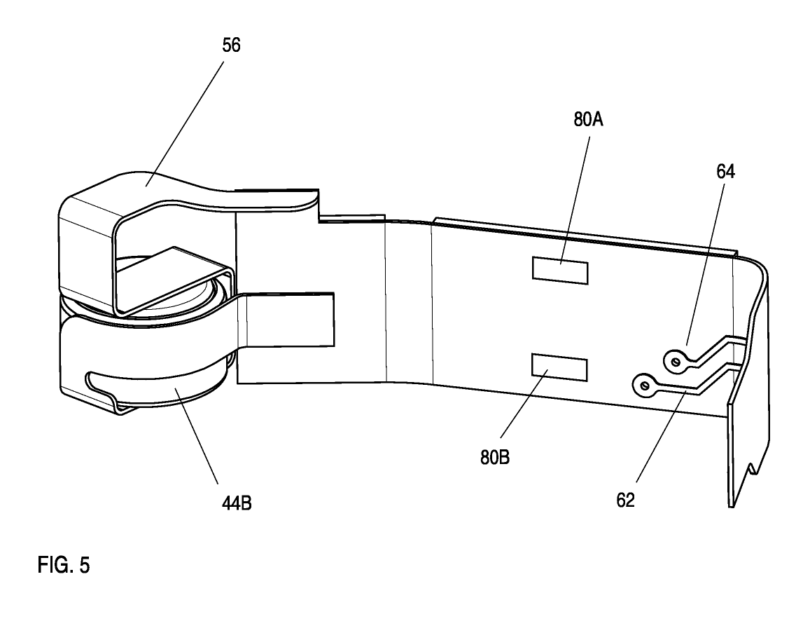

Referring now to FIG. 2, ring 4 is shown without top cap 8 and bottom cap 4. A rigid-flex printed circuit board assembly (hereafter PCBA) 12 and a rechargeable battery 44A and 44B are located inside top cavity 16. As shown in FIG. 5, flexible PCBA 12 includes a portion with multiple bends that wraps around and functionally connects battery 44A and battery 44B in parallel. Batteries 44A and 44B are comprised of silver zinc chemistry and each of battery 44A and 44B have a full charge voltage of 1.85V and a capacity of 14 milli-amp hours (mAh). Battery 44A and 44B connected in parallel therefore provide a maximum of 1.85V and 28 mAh of electric charge.

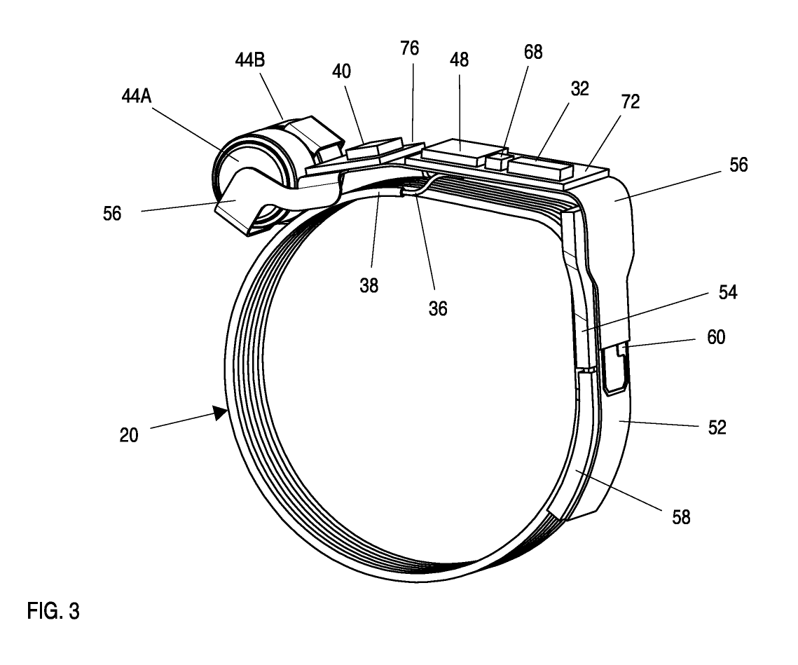

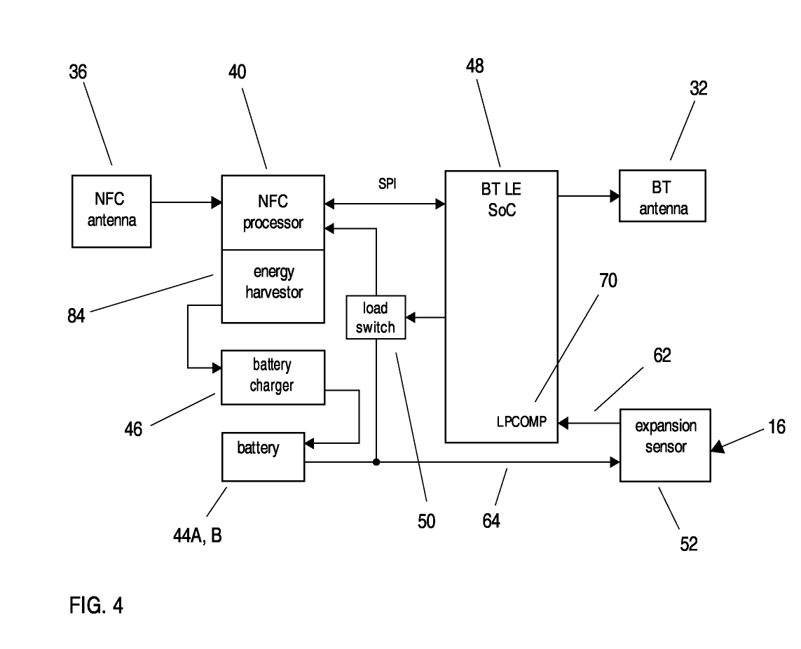

FIG. 3 and FIG. 4 further describe the electrical sub-system in device 4. Flexible PCBA 12 is of a rigid-flex type construction comprised of a flexible printed circuit board 56, a large rigid board section 72, and small rigid board section 76. Flexible printed circuit board 56 is comprised of laminated polyimide film with copper circuit traces. The major components on large board 56 are a Bluetooth Low Energy System-on-a-Chip (SoC) 48, a balun 68, and a 2.4 Ghz chip antenna 32. Bluetooth SoC 48 is part number nRF51822 manufactured by Nordic Semiconductor ASA of Oslo, Norway. In this embodiment Bluetooth SoC 48 is the Wafer Level Chip Scale Package (WLCSP) package version, which measures 3.5 mm×3.83 mm×0.15 mm. Antenna 32 is an Indica chip antenna manufactured by Antenova of Cambridge, England, and 32 measures 3.3 mm×1.6 mm×0.65 mm. Large board 56 also includes various other electrical components, such as 0201 and 01005 size surface mount passive components that will not be described here in detail.

A Near-Field-Communication (NFC) integrated circuit (IC) 40 is soldered to small board 76. NFC IC 40 is a custom secure dual interface IC that is identical in basic function to ICs used in SmartCards, but with several additional functions. NFC IC 40 includes the following sub-systems: ARM® SecurCore® SC000™ 32-bit RISC core; radio-frequency universal asynchronous receiver (RFUART); flash memory; ISO/IEC 14443 Type A and Type B compliant communication sub-system; AES cryptographic accelerator; SPI slave communication port with AES encryption; and a DC power sub-system for powering NFC IC 40 from a battery. NFC IC 40 therefore can be powered by battery 44A and 44B, or from the RF energy source provided by an NFC reader 40. Note that for conventional 14443 compliant contactless communication, only NFC IC 40 is utilized and is powered completely by the AC magnetic field generated by NFC reader 40—power from battery 44A and 44B is not used.

Referring now to FIG. 4, PCB assembly 12 also includes a load switch 50, the NCP432 Ultra-Small Controlled Load Switch manufactured by ON Semiconductor of Phoenix, Ariz., and a battery charger IC 46. The control input of load switch 50 is connected to a BLE IC 48 GPIO port, the load input is connected to battery 44A and 44B, and the load output is connected to the power input to NFC IC 40. Battery charger 46 applies a charging voltage to batteries 44A and 44B when energy harvester 84 captures charge from NFC coil 36.

In another embodiment, NFC IC 156 includes integrated energy harvesting and battery charging sub-systems for accumulating charge from the RF energy received during NFC communications or from an inductive charging station 36, to charge battery 44A and 44B.

In another embodiment, an energy harvesting and battery charging IC 160 is included in flexible PCBA 12 for the purpose of accumulating charge from the RF energy received during NFC communications or from an inductive charging station 36, to charge battery 44A and 44B.

FIGS. 2, 3 and 4 show that device 4 includes an NFC antenna 20 comprised of a metal wire coil 36 covered with an insulating Teflon sheath 38. FIG. 5 shows that NFC coil 36 is soldered to solder pad 80A and 80B, respectively on the bottom of flexible circuit 56, and traces on flexible PCBA 12 functionally connect NFC coil 36 to the antenna inputs on NFC IC 40. NFC coil 36 inductance in combination with NFC IC 40 capacitance and system capacitance comprise a circuit that resonates substantially at 13.56 Mhz. The presence of the human finger inside coil 36 is also taken into consideration in practice. The basic equation for system impedance tuning is:

$${f}_{res} = \frac{1}{2 π \times \sqrt{{L}_{coil} \times {C}_{NFC}}}$$

where fᵣₑₛ is the resonance frequency, L_{coil} is the inductance of NFC coil 36, and C_{NFC} is the combined capacitance of NFC IC 40 and other system capacitance.

Ring 4 will be provided in a range of sizes corresponding to conventional ring sizes based on internal ring diameter. NFC coil 36 parameters including effective diameter, number of coils, coil pitch, and wire diameter will be adjusted for various size rings, and in combination with varying system capacitances, will produce a circuit that substantially resonates at 13.56 Mhz, so that communication with NFC reader 40 is accomplished.

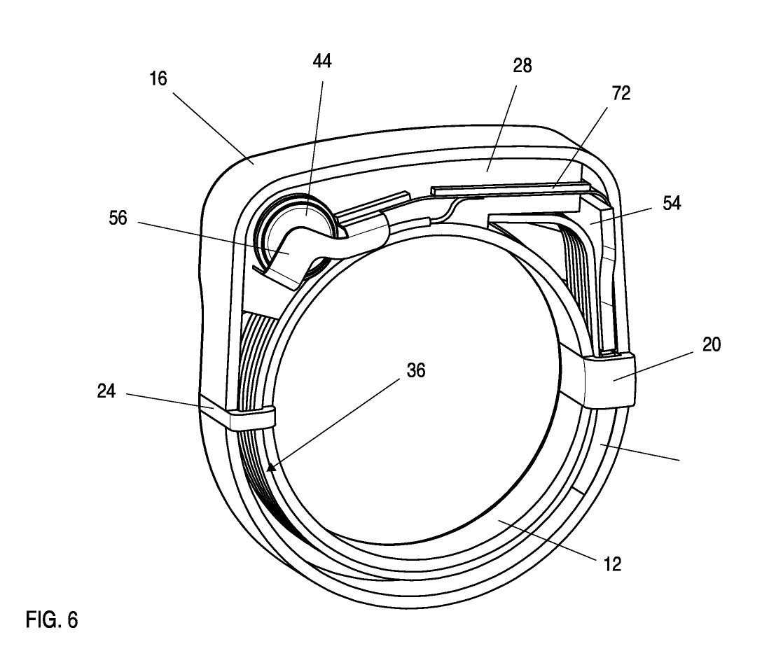

Referring now to FIG. 6, during the assembly of ring 4, after flexible PCBA 12, batteries 44A and 44B, and NFC coil 20 are in place, top cavity 16 is filled with an epoxy encapsulant 28. Encapsulant 28 epoxy hardens and encases flexible PCBA 12, battery 44 as a protection against hacking. Encapsulant also increases the structural strength of external enclosure 8.

### Expansion Sensor Subsystem and Components

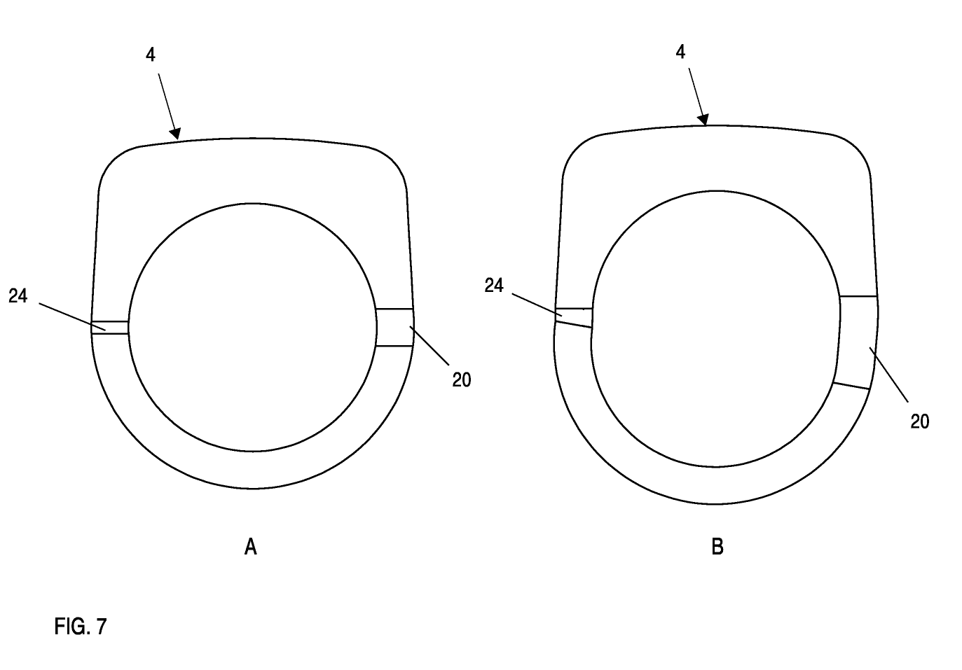

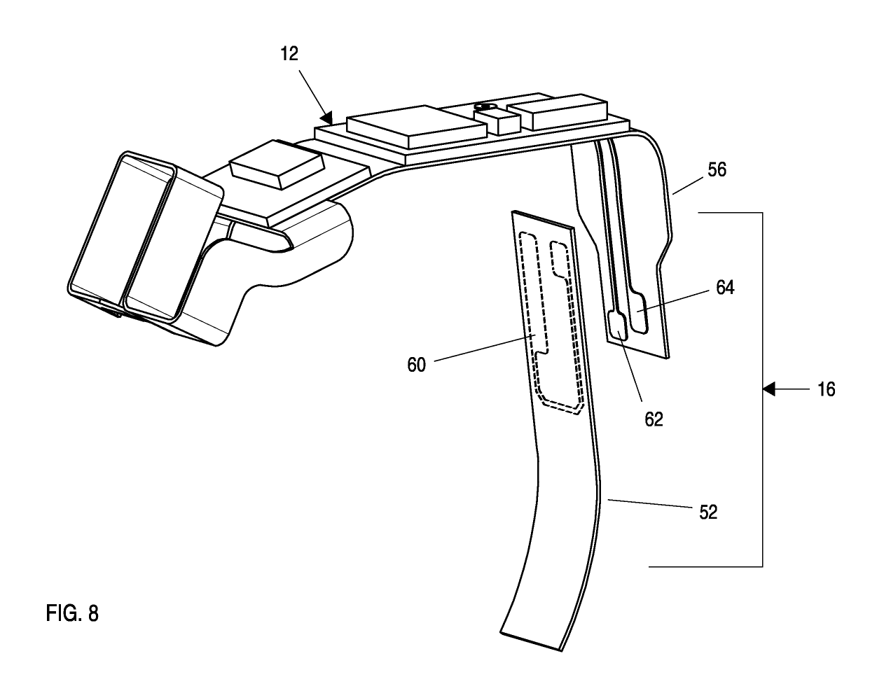

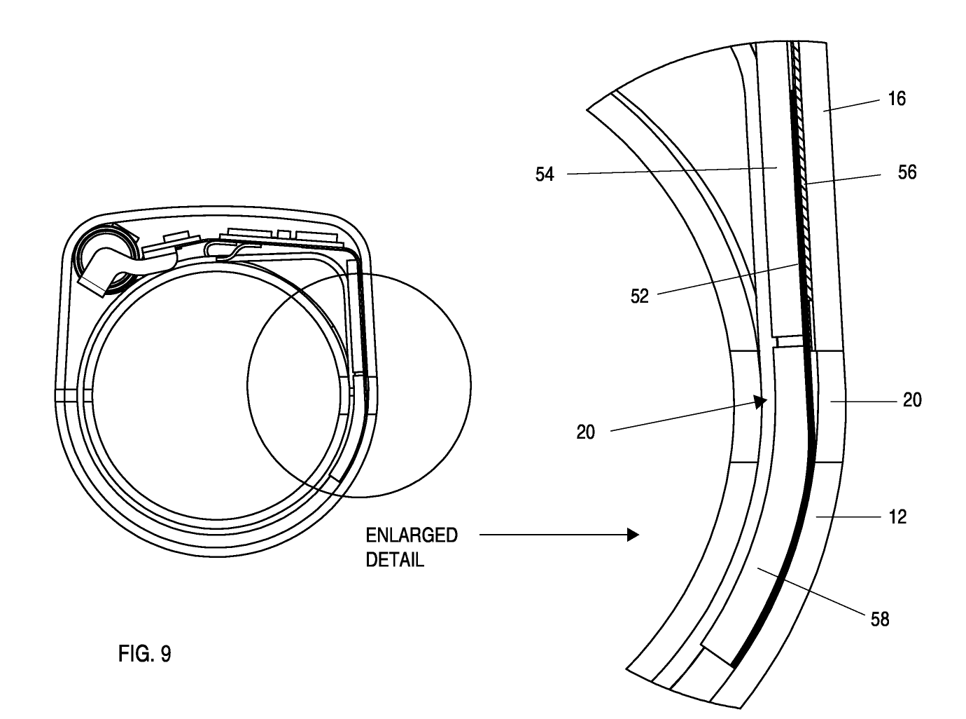

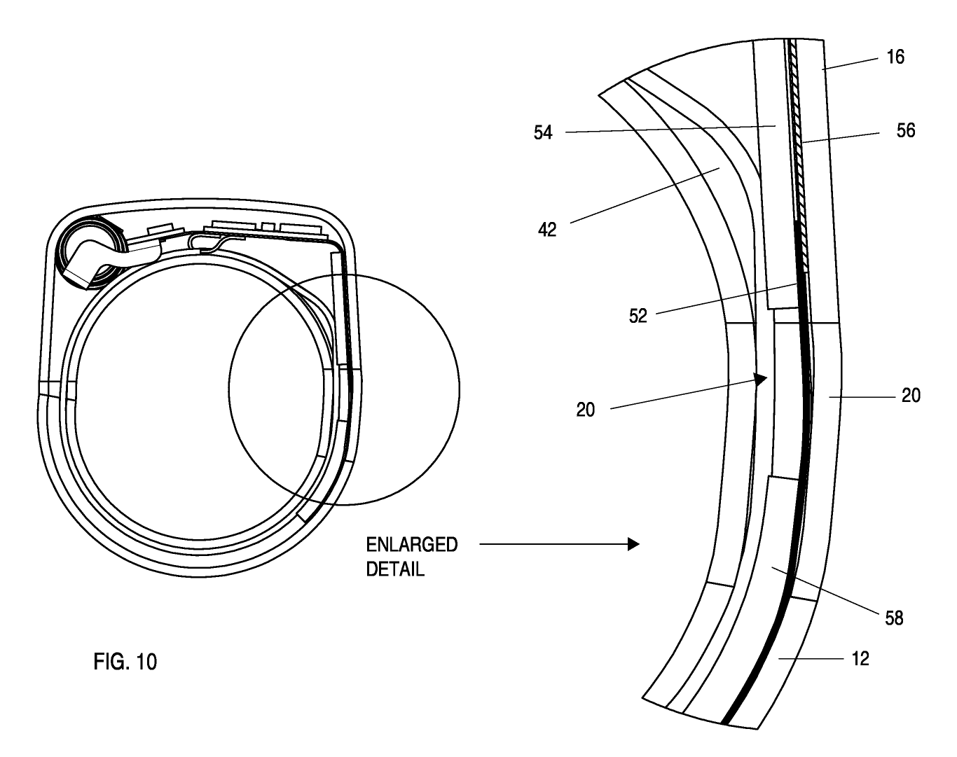

Due to the flexibility of hinge 24 and expander 20, bottom enclosure 24 can rotate with respect to top enclosure 26. FIG. 7A shows ring 4 in a static contracted state, for example when ring 4 is worn on the ring finger in the middle of the metacarpal segment. FIG. 7B shows ring 4 in an expanded state, for example when ring 4 is in the process of being removed from the finger and is pulled over the knuckle between the metacarpal and proximal phalanges. Referring now to FIG. 3 and FIG. 8 which shows the expansion flex sub-assembly 16, an expansion flex 52 is a flexible circuit fabricated out of laminated polyimide film with gold-plated copper circuit traces. Referring now also to FIG. 3, and FIG. 9 and FIG. 10 where expansion flex 52 is drawn as solid black and flex circuit 56 is drawn with cross hatch, expansion flex 52 is fixedly attached by epoxy adhesive to plug 58 which is comprised of substantially dense polyurethane foam. Plug 58 is fixedly attached to bottom cavity 12 by epoxy adhesive. Epoxy adhesive is also used to fixedly attach NFC coil 20 to plug 58 and to bottom cavity 12.

Epoxy adhesive is used to attach wide, vertical portion of flexible circuit 56 to the vertical inner wall of top cavity 16 in the area where flex circuit 56 and top cavity 16 are in apposition. Gasket 54 is comprised of polyurethane closed cell foam, and gasket 54 narrow edge is adhered to the rear inner wall of top cavity 16 and the narrow edge on the opposite side of gasket 54 is adhered to the inner wall of top cap 8.

As shown in FIG. 7, expander 20 has sufficient length so that when ring 4 transitions to the expanded state, expander 20 is stretched and bottom cap 4 and bottom cavity 12 rotate substantially about hinge 24. FIG. 9 shows a cross section of expansion sensor 16 in the contracted state, and FIG. 10 shows a cross section of expansion sensor in the expanded state.

As bottom enclosure 24 moves to the expanded state, expansion flex 52 slides with respect to flexible circuit 56 and gasket 54, and the substantially vertical portion of NFC coil 20 slides with respect to gasket 54.

FIG. 8 shows that expansion flex 52 includes an expansion circuit trace 60 located on the side of expansion flex 52 that is facing flex circuit 56. Referring now to FIG. 8 and FIG. 4, flex circuit 56 includes a power wake circuit trace 64 that is connected to the battery 44A and 44B, and a wake circuit trace 62 that is connected wake port 70, which is the low power comparator (LPCOMP) analog port on Bluetooth SoC 48. Expansion circuit 60 is a single trace that is plated with 3 ounce copper with a finish layer of gold plating. Therefore expansion circuit trace extends above flex 52 polyimide film surface by at least 0.1 mm.

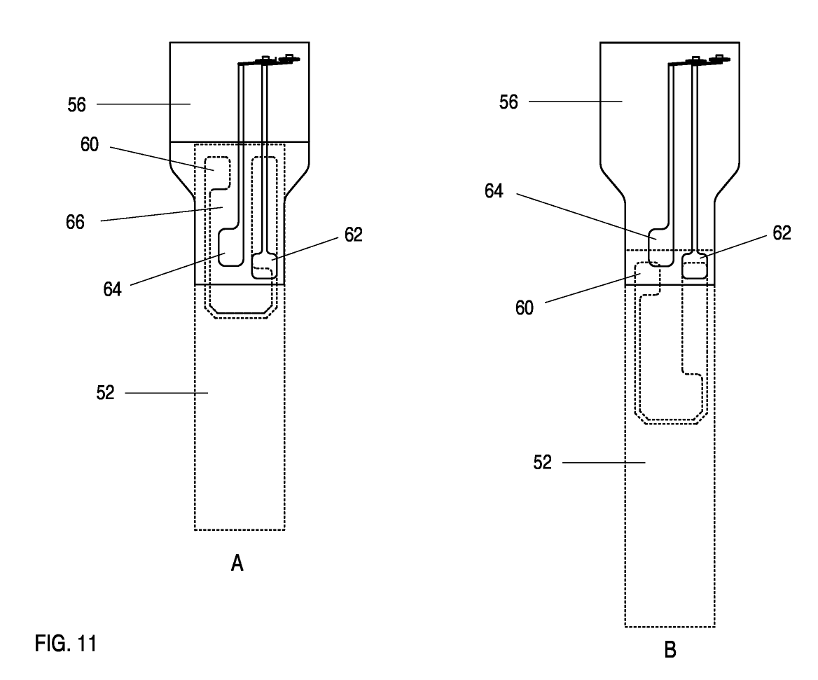

FIG. 11 is a side view showing the position of expansion flex 52 and expansion trace 60 relative to flexible circuit 56 in the contracted and expanded states. FIG. 11A shows the contracted (static) state where expansion trace 60—shown with a dashed line—is in contact with wake circuit trace 62 but is not in contact with power circuit trace 64. In this embodiment the trace gap 66 between the closest edges of power circuit trace 64 and expansion trace 60 respectively, is 1.6 mm. During expansion, when expansion flex 52 exceeds 1.6 mm of travel with respect to flex circuit 56, expansion trace 60 makes electrical contact with power circuit trace 64. Expansion circuit is always in electrical contact with wake circuit trace 62, therefore the battery voltage will be applied to BLE IC 48 wake port 70, causing BLE IC 48 to exit OFF mode and execute a software application 104. Slight compression of gasket 54 against expansion flex 52 insures that expansion circuit 60 makes electrical contact with wake circuit 62 and power circuit 64.

In this embodiment NFC coil 20 must flex to allow rotation of the bottom enclosure 24. FIG. 2 shows that NFC coil 36 shape includes a spring lobe shape 42 that flexes when ring 4 is expanded. NFC wire coil 36 is comprised of a beryllium copper alloy with a sufficient modulus of elasticity to allow for the required flexing and return to NFC coil 36 contracted state shape without yielding.

### Description of the Embodiments

### Software

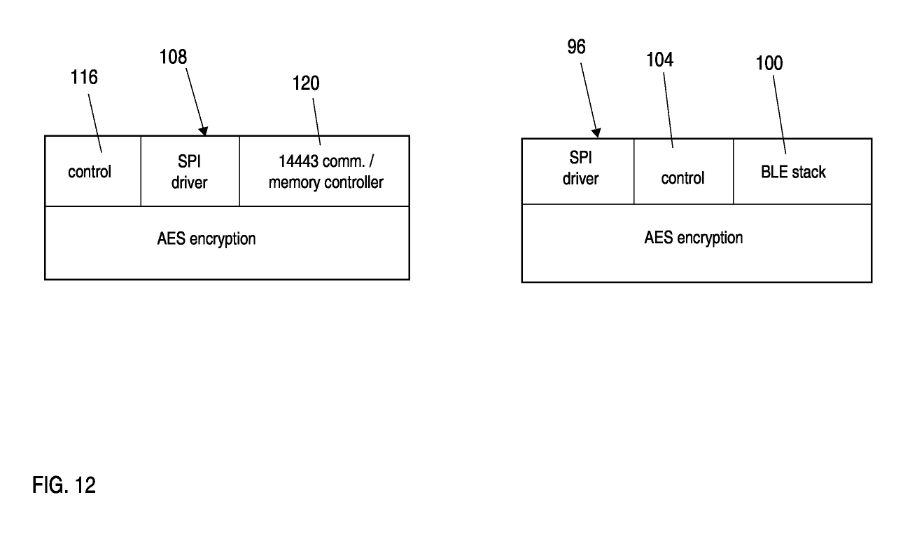

FIG. 12 shows the software components in ring 4—an NFC software application 108 and a Bluetooth LE software application 96. Additionally, ring 4 requires a PIN (Personal Identification Number) confirmation app 112 running on a Bluetooth LE central device 22 such as a smartphone, tablet, or PC.

PIN confirmation app 112 is a software application that runs on a smartphone, such as an Android OS device or an Apple device running iOS, or other mobile device 22 such as a tablet. PIN app 112 utilizes the Bluetooth LE communication subsystem found on most mobile devices.

NFC software application 108 runs on the ARM core processor in NFC IC 40 and includes an NFC communication application 120 with a function identical to that found in conventional contactless Smart Card ICs that executes encrypted 14443-compliant data communication for the purpose of enabling financial and other transactions. Additionally, NFC application 108 includes a control application 116 for communicating with Bluetooth SoC 48 via an encrypted SR communication link and for enabling and disabling the 14443 communication function and for other functions associated with setup and control of device 4. NFC IC 40 includes an ENABLE status register 162, the status of which is stored in flash memory. The state of ENABLE register is either TRUE—NFC secure transaction function enabled, or FALSE—NFC secure transaction function disabled.

Bluetooth LE application 96 runs on the ARM Cortex MO 32-bit processor in Bluetooth SoC 48, and includes a Bluetooth LE stack 100 portion that provides the basic functions for a Bluetooth LE peripheral including PHY control, advertising, responding to a scan, linking, and bonding with a Bluetooth master (central) device 22. The Bluetooth LE stack 100 and function is described in detail in the Bluetooth© Core Specification, available on the Bluetooth SIG website—www.bluetooth.org—and is incorporated here by reference.

Bluetooth application 96 also includes a custom state control program 104 portion for communicating and controlling the power state (via power management component 50) and functional state of NFC IC 40, for communicating with PIN app 112 via the Bluetooth LE RF link, and for modifying the functional state of BLE IC 48.

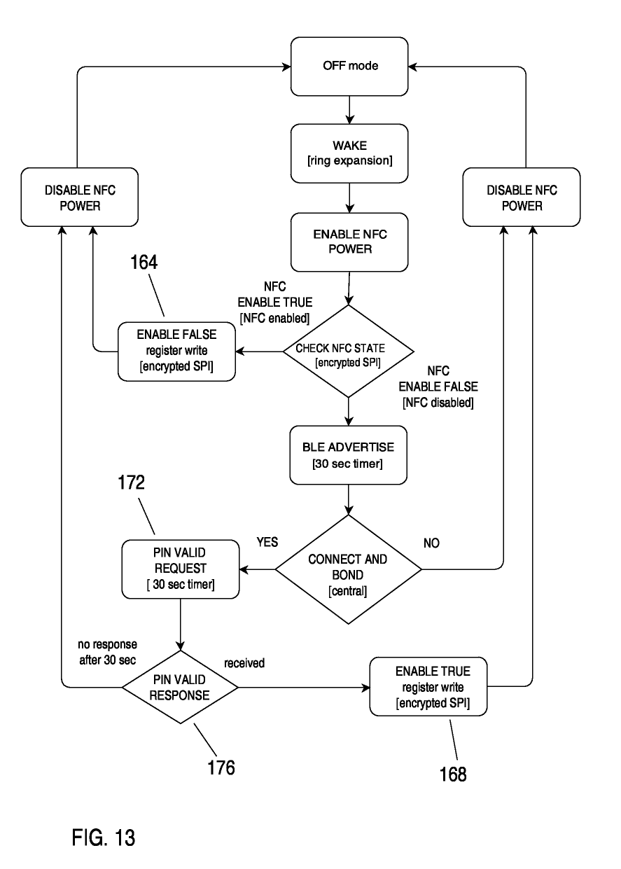

FIG. 13 is a flow chart showing the execution of BLE state control program 104. Under normal operating circumstances when ring 4 is worn on the finger, all components are powered off except for BLE IC 48 which is in a low power OFF mode. In OFF mode, the total power consumption of ring 4 is approximately 1 μW. Based on the energy capacity of battery 44A and 44B, device 4 will function for more than five years in OFF mode.

When device 4 is removed from the finger, expansion sensor 16 is triggered and BLE IC 48 is activated by V+ (1.85V battery) connected to BLE IC 48 wake port 70. Device 4 now exits OFF mode and executes control program 104. BLE control program 104 then connects NFC IC 40 to battery power by switching on load switch 50. Next, BLE IC 48 reads state of the ENABLE register 162 in NFC IC 40 via the encrypted SPI link. If NFC IC 40 ENABLE register 162 state is TRUE, then BLE program 104 writes an ENABLE FALSE 164 (disable) instruction to NFC IC 40 ENABLE register 162, turns off power to NFC IC 40, and instructs BLE IC 48 to enter OFF mode. When NFC IC 40 is disabled, NFC data transfers to enable secure, authenticated transactions will not occur.

If BLE program 104 reads FALSE from NFC IC 40 ENABLE register 162, BLE program 104 enables the radio and commences broadcasting BLE encrypted advertising packets for a maximum of 30 seconds. If after 30 seconds device 4 is not able to connect with central device 22, BLE program 104 powers off NFC IC 40 (NFC function still disabled) and instructs BLE IC 48 to enter OFF mode.

If central device 22 connects and bonds to device 4, BLE program 104 sends a PIN VALID REQUEST message to central device 22 and starts a 30 second timer. Note that all communication over a bonded BLE RF link is encrypted. PIN confirmation app 112 must be running on the mobile device 22 to respond to the PIN VALID REQUEST message. The function of PIN app 112 will be described below.

If BLE program 104 receives a PIN VALID RESPONSE message from central device 22 in response to the PIN VALID REQUEST message, BLE program 104 writes ENABLE TRUE instruction to ENABLE register 162, turns off power to NFC IC 40, tears down the BLE connection, and instructs BLE IC 48 to enter OFF mode. NFC IC 40 is now enabled to communicate with NFC readers 40 for executing transactions.

If BLE program 104 does not receive a PIN VALID RESPONSE message from central device 22 within the 30 second time period (PIN app 112 is not running on mobile device 22, the user does not respond or inputs an incorrect PIN), BLE program 104 powers down NFC IC 40 (NFC function still disabled), tears down the BLE connection to central device 22, and then instructs BLE IC 48 to enter OFF mode.

Referring now to FIG. 13, PIN VALID REQUEST is directed to PIN app 112. If device 4 is connected and bonded to mobile device 22 and PIN app 112 is running on mobile device 22 but PIN app 112 user interface is not currently shown on mobile device 22 display, PIN app 112 will send a notification to be displayed on mobile device display to notify the user that ring 4 device is active and requires an action by the user. If user activates PIN app 112, a six-character PIN entry interface is shown on mobile device 22 display. When the user enters a PIN in the PIN entry interface, PIN app 112 software executes the function of comparing the entered PIN to the PIN stored in mobile device 22 memory and if the entered PIN matches the PIN in memory, PIN app 112 sends a PIN VALID RESPONSE message to BLE IC 48 and device 4 executes the process as described above, and the NFC secure transaction function is enabled. If the entered PIN does not match the PIN stored in memory, PIN app 112 does not respond to device 4, but a PIN INVALID—RE-ENTER message is triggered by PIN app 112 to display on mobile device 22 display. If the user does not enter a matching PIN before the 30 second time period, BLE program 104 tears down the BLE connection and instructs BLE IC 40 to enter OFF mode as described above.

### Description of the Embodiments—Function

The function of device 4 will be described from the point of view of the user's experience. The internal functions of ring 4 have been described in detail, therefore only pertinent new technical functional information will be included here.

### Initial Setup

When ordering ring 4 from the supplier, the user creates an account on ring 4 supplier's website, creating a username and password, and provides identity information, for example the user's SSN, and the bank account information for the account that will be used to make payments with ring 4. Ring 4 is shipped from the factory with a Bluetooth pairing code 132 and a unique factory device code 128 stored in ROM that is associated with the user's identity information and bank account data the supplier's database. In the factory state, battery 44A and 44B are fully charged, and NFC IC 40 is in a disabled state. The user is instructed install and start up PIN app 112 on mobile device 22 that they will use regularly. The user is required to sign in to the app using the username and password for the ring 4 supplier online account.

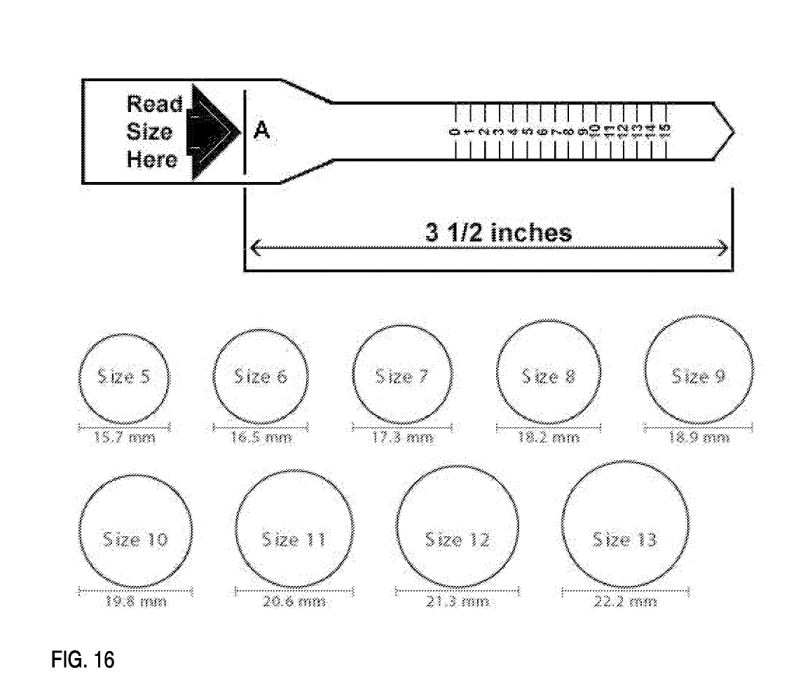

During the application process the user selects a size from a ring size chart using an existing ring, or uses a ring measurement strip, such as shown in FIG. 16, and downloadable from the website and printed.

When device 4 is placed on the finger for the first time, ring 4 expands and BLE IC 48 is powered on. Mobile device 22 operating system responds to ring 4 BLE advertisements and generates a pairing code input interface on mobile device 22 display. When factory pairing code 132 is input correctly by the user, device 4 will be connected and bonded with mobile device 22. Next, a PIN entry interface generated by PIN app 112 is presented to the user on mobile device 22 display. The user will create and enter a six digit PIN which is stored in mobile device 22 memory and also backed up in supplier's cloud database. PIN app 112 then sends a PIN VALID RESPONSE message to device 4 which enters a fully functional state and can be used for transactions with valid NFC reader 40 devices.

Alternatively, the user may acquire a ring 4 device at a retail location, such as a bank or a mobile device carrier store (AT&T, Verizon, and the like). In this retail setting the user may initially try on non-functional rings for determining the correct ring size before receiving a functional ring 4 device.

### Everyday Use for Making Payments

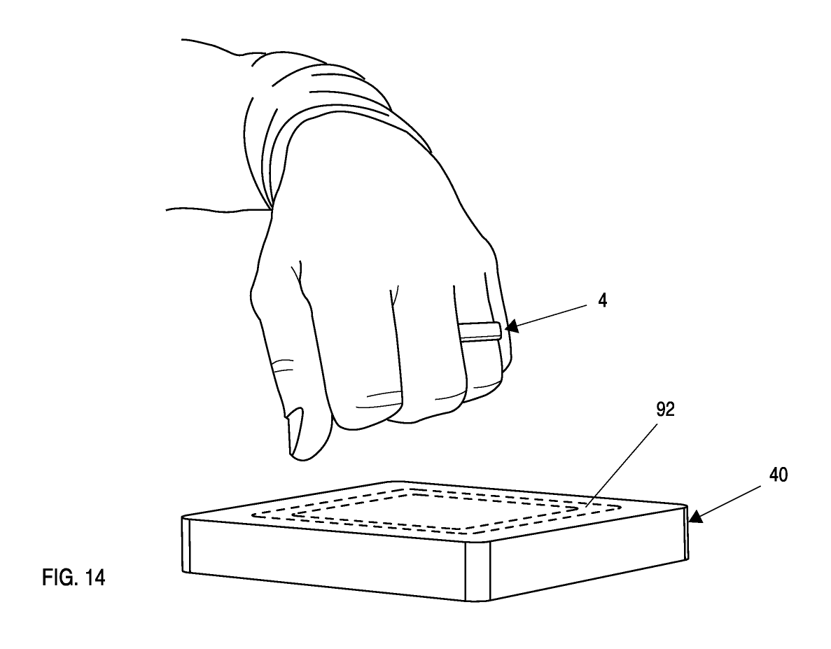

When NFC IC 40 is enabled, ring 4 can be used to make various NFC transactions, such as financial transactions that require secure identity authentication as well as financial data. For example, to make a payment in a grocery store checkout line, the user places their left hand with ring 4 on the left ring finger, in close proximity to NFC reader 40 as shown in FIG. 14, where the orientation of ring 4 NFC coil 20 is in substantially the same plane as NFC reader coil 92. This orientation maximizes the inductive coupling of NFC coil 20 and NFC reader coil 92. In a few seconds RF communication between ring 4 and NFC reader 40 completes and the data is sent to the various transaction constituents for approval.

### Removing and Donning

When removed from the finger (ring is expanded) ring 4 no longer functions for transactions. Ring 4 is disabled for transactions until ring 4 is placed back on the finger (ring is expanded) and the correct PIN is entered into PIN app 112 running on mobile device 22.

In this embodiment ring 4 is meant to be worn permanently, much like a wedding band or other ring that is ornamental. When worn permanently and used for NFC transactions, virtually no battery 44A and 44B power is used.

The power consumption for one cycle of removing ring 4 (disabling NFC IC 40) and donning ring 4 (enabling NFC IC 40 by BLE communication with mobile device 22) will use approximately 0.17 mAh, or 0.6% of the charge stored in battery 44A and 44B. For example removing ring 4 once per week for a year would reduce the battery life of ring 4 down to approximately 3.5 years.

### Alternative Embodiments—Charging

In another embodiment where ring 4 includes an energy harvesting sub-system, energy from the NFC transaction is captured and returned to charge battery 44A and 44B. An example of such an energy harvesting sub-system is included in the M24LR16E-R, a Dynamic NFC/RFID tag IC, manufactured by ST Microelectronics of Geneva, Switzerland. The M24LR16E-R routes excess energy (energy that the IC does not use to operate) to an analog power output pin. This sub-system is combined with an LTC3588 Nanopower Energy Harvesting Power Supply IC, provided by Linear Technology of Milpitas, Calif.

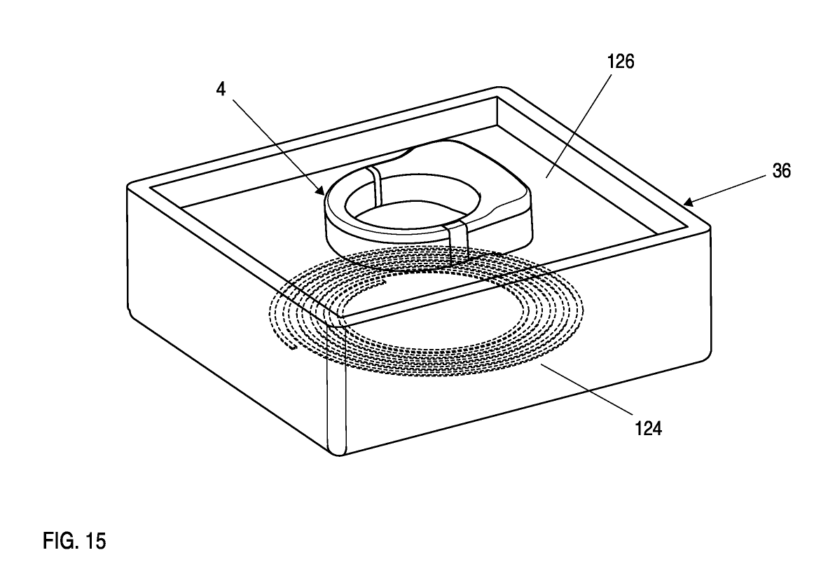

Referring now to FIG. 15, ring 4 energy harvesting and battery charging sub-system may be charged by an inductive charging station 36, which is a platform for charging that includes an inductive charging coil 124—shown with a dashed line—that is driven by DC-AC conversion electronics in a charging electrical sub-system 38 to resonate at 13.56 Mhz. Charging coil 124 is located below the charging platter surface 126. Inductive charging station 36 is powered by an AC-DC converter that is plugged into any AC outlet. The user charges ring 4 by placing ring 4 on charging platter 126. A pressure sensor 136 is integrated into charging platter 126 and is connected to charging electrical sub-system 38 such that when ring 4 is not present on platter 126, coil 124 is not energized. When ring 4 is placed on charging platter 126, sensor 136 triggers charging sub-system 38 to energize coil 124, thereby charging ring 4.

In another embodiment ring 4 includes an external gold-plated charging contact 180A and 180B that mate with a charging adapter 184 that is powered by an AC-DC converter or a USB connection. In this embodiment, ring includes a 5V battery charging IC and related components.

### Ring Designs

In another embodiment, jewel ring 28 includes all of the components and functions described herein but also includes one or more ornamental jewel.

### OTHER ALTERNATIVE EMBODIMENTS

In another embodiments, separate NFC IC 40, BLE IC 48, energy harvesting IC 84, and battery management and charging IC 50 are all integrated onto a single integrated circuit. The advantage is a reduction in size and power consumption.

In another embodiment, a latching circuit is used to apply power to the Bluetooth IC, so that the IC can be powered off, thereby using no electrical energy in everyday use for executing NFC transactions.

In another embodiment, the wearable authentication device need not be in a ring format. It could for example be in the form of a bracelet, or wrist watch with an expansion sensor similar in function to expansion sensor 16.

The sensor that senses the removal of the device need not be an expansion sensor such as the one described in the above embodiment. In another embodiment, a bracelet or watch includes a clasp with a metal contact that makes and breaks a conductive connection that is connected to BLE IC 48 when the device is donned, and makes and breaks the conductive connection when the device is removed. But the function of BLE IC 48, NFC IC 40 and BLE application 96, NFC application 108, and mobile device app 112 remains the same.

In another embodiment, the fingerprint identification function on a smartphone, such as an iPhone 6, is used to validate the identity of the ring wearer, in place of or in addition to entering a PIN. Upon successful confirmation validation of the user's fingerprint, PIN app 112 then sends a PIN VALID RESPONSE message to device 4 which enters a fully functional state and can be used for transactions with valid NFC reader 40 devices.

It is to be understood that the present invention is not limited to the embodiment(s) described above and illustrated herein, but encompasses any and all variations falling within the scope of the appended claims.

What is claimed is:

1. A device for providing identity authentication comprising:
an enclosure for providing attachment to the human body,
a passive sensor for sensing the donning of the device to the body and for sensing the removal of the device from the body,
a secure passive NFC communication sub-system configured to provide authentication of an identity associated with the device,
a secure wireless data communication sub-system for receiving identity confirmation data,
a battery for powering the wireless data communication sub-system and the NFC communication sub-system,
a software program for disabling a currently enabled NFC communication sub-system when the passive sensor is triggered, and for enabling a currently disabled NFC communication sub-system when the passive sensor is triggered and when identity confirmation data is received from an external device via the secure wireless data communication sub-system.

2. The device of claim 1 where the enclosure is in the form of a finger ring.

3. The device of claim 1 where the passive sensor is comprised of a fixed circuit contact and a slidable circuit contact.

4. The device of claim 1 where the enclosure includes a hinge member and a stretchable member.

5. The device of claim 1 where the enclosure is configured as a hollow substantially toroidal form with a partially circular NFC antenna concentric to the toroidal void inside of the enclosure.

6. The device of claim 1 where the currently disabled NFC communication sub-system is enabled if the identity confirmation data is received from the external device within 30 seconds of the passive sensor trigger.

7. The device of claim 1 where the interior space of the device is filled with an encapsulant.

8. A finger ring for providing identity authentication comprising:
a hollow substantially toroidal enclosure assembly comprising a top enclosure, a bottom enclosure, a hinge member, and a stretchable member;
a passive NFC processor for executing encrypted identity authentication and data transactions with an NFC base station,
a Bluetooth LE microprocessor for executing software instructions and for communicating with a computing device,
a battery,
an NFC antenna coil configured substantially concentric to and inside the toroidal enclosure, electrically connected to the NFC processor, and with a lobe shape that deflects to allow the bottom enclosure to rotate away from the top enclosure about the hinge member;
a rigid flex circuit board functionally connecting the passive NFC processor, the Bluetooth LE microprocessor, battery, an NFC antenna, and a Bluetooth antenna chip;
a passive sensor comprising a first contact fixedly attached to the top enclosure and connected to the positive voltage side of the battery, a second contact fixedly attached to the top enclosure and connected to a wake-up port on the Bluetooth processor, and a third contact fixedly attached to the bottom enclosure and protected by the stretchable member, that electrically connects the first contact and the second contact when one end of the bottom enclosure is displaced a specific distance from the corresponding end of the top enclosure, thereby waking the Bluetooth LE microprocessor;
a software application running on a computing device with an encrypted Bluetooth connection to the ring Bluetooth LE microprocessor for acquiring and validating a user's personal identification number and sending an identity confirmation data message to the Bluetooth LE microprocessor, and
a software application running on the Bluetooth chip that disables a currently enabled NFC processor when the Bluetooth LE microprocessor is powered on, and enables a currently disabled NFC processor when the Bluetooth LE microprocessor is powered on and receives an identity confirmation data message from the computing device.

9. The device of claim 8 where the currently disabled NFC communication sub-system is enabled if the identity confirmation data message is received from the external device within 30 seconds of the passive sensor trigger.

10. The device of claim 8 where the internal voids in the top enclosure are substantially filled with encapsulant.
